(19) United States
(12) Patent Application Publication
(10) Pub. No.: US 2024/0177387 A1
(43) Pub. Date: May 30, 2024

(54) CONVERSION OF SENSOR-BASED PEDESTRIAN MOTION INTO THREE-DIMENSIONAL (3D) ANIMATION DATA

(71) Applicant: GM Cruise Holdings LLC, San Francisco, CA (US)

(72) Inventor: Kyle Smith, Frankfort, IL (US)

(73) Assignee: GM Cruise Holdings LLC, San Francisco, CA (US)

(21) Appl. No.: 18/059,039

(22) Filed: Nov. 28, 2022

(51) Int. Cl. G06T 13/40; G06T 7/20

(52) U.S. Cl. CPC G06T 13/40; G06T 7/20; G06T 2207/10016; G06T 2207/10028; G06T 2207/20081; G06T 2207/30196; G06T 2207/30252

(57) ABSTRACT

Systems and methods for generating three-dimensional (3D) animation from real-world road data are provided. For instance, a computer-implemented system comprising one or more processing units; and one or more non-transitory computer-readable media storing instructions, when executed by the one or more processing units, cause the one or more processing units to perform operations comprising obtaining real-world road data including a sequence of images of a real-world driving environment across a time period, the sequence of images including at least one moving character in the real-world driving environment; generating a sequence of skeletal data representing the moving character and corresponding movements across the time period by processing the real-world road data; and outputting a motion library including the sequence of skeletal data.

### BACKGROUND

### 1. Technical Field

The present disclosure generally relates to autonomous vehicles and, more specifically, to generation of three-dimensional (3D) animation data using sensor-based pedestrian motion.

### 2. Introduction

Autonomous vehicles, also known as self-driving cars, driverless vehicles, and robotic vehicles, may be vehicles that use multiple sensors to sense the environment and move without human input. Automation technology in the autonomous vehicles may enable the vehicles to drive on roadways and to accurately and quickly perceive the vehicle's environment, including obstacles, signs, and traffic lights. Autonomous technology may utilize map data that can include geographical information and semantic objects (such as parking spots, lane boundaries, intersections, crosswalks, stop signs, traffic lights) for facilitating the vehicles in making driving decisions. The vehicles can be used to pick up passengers and drive the passengers to selected destinations. The vehicles can also be used to pick up packages and/or other goods and deliver the packages and/or goods to selected destinations.

### BRIEF DESCRIPTION OF THE DRAWINGS

The various advantages and features of the present technology will become apparent by reference to specific implementations illustrated in the appended drawings. A person of ordinary skill in the art will understand that these drawings show only some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example three-dimensional (3D) motion data generation scheme that utilizes camera images, according to some examples of the present disclosure;

FIG. 2 illustrates an example 3D motion data generation scheme that utilizes camera images and light detection and ranging (LIDAR) data, according to some examples of the present disclosure;

FIG. 3A illustrates an example machine learning (ML) model training scheme for training a ML model to generate 3D motion data from real-world road data, according to some examples of the present disclosure;

FIG. 3B illustrates example annotated sensor data, according to some examples of the present disclosure;

FIG. 3C illustrates an example 3D bounding box in a LIDAR point cloud enclosing a moving character, according to some examples of the present disclosure;

FIG. 4 illustrates an example simulation platform with 3D animation for training, development, and/or testing of an autonomous vehicle (AV) software stack, according to some examples of the present disclosure;

FIG. 5 is a flow diagram illustrating a process for generating a 3D motion library from real-world road data captures, according to some examples of the present disclosure;

FIG. 6 is a flow diagram illustrate a process for training an ML model to generate a 3D motion library from real-world road data captures, according to some examples of the present disclosure;

FIG. 7 illustrates an example system environment that may be used to facilitate AV dispatch and operations, according to some aspects of the disclosed technology;

FIG. 8 illustrates an example of a deep learning neural network that may be used to generate a 3D motion library, according to some aspects of the disclosed technology; and

FIG. 9 illustrates an example processor-based system with which some aspects of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Autonomous vehicles (AVs) can provide many benefits. For instance, AVs may have the potential to transform urban living by offering opportunities for efficient, accessible and affordable transportation. An AV may be equipped with various sensors to sense an environment surrounding the AV and collect information (e.g., sensor data) to assist the AV in making driving decisions. To that end, the collected information or sensor data may be processed and analyzed to determine a perception of the AV's surroundings, extract information related to navigation, and predict future motions of the AV and/or other traveling agents in the AV's vicinity. The predictions may be used to plan a path for the AV (e.g., from a starting position to a destination). As part of planning, the AV may access map information and localize itself based on location information (e.g., from location sensors) and the map information. Subsequently, instructions can be sent to a controller to control the AV (e.g., for steering, accelerating, decelerating, braking, etc.) according to the planned path.

The operations of perception, prediction, planning, and control of an AV may be implemented using a combination of hardware and software components. For instance, an AV stack or AV compute process performing the perception, prediction, planning, and control may be implemented using one or more of software code and/or firmware code. However, in some embodiments, the software code and firmware code may be supplemented with hardware logic structures to implement the AV stack and/or AV compute process. The AV stack or AV compute process (the software and/or firmware code) may be executed on processor(s) (e.g., general purpose processors, central processing units (CPUs), graphical processing units (GPUs), digital signal processors (DSPs), application specific integrated circuits (ASICs), etc.) and/or any other hardware processing components on the AV. Additionally, the AV stack or AV compute process may communicate with various hardware components (e.g., onboard sensors and control systems of the AV) and/or with an AV infrastructure over a network.

Training and testing AVs in the physical world can be challenging. For instance, to provide good testing coverage, an AV may be trained and tested to respond to various driving scenarios (e.g., millions of physical road test scenarios) before it can be deployed in an unattended, real-life roadway system. As such, it may be costly and time-consuming to train and test AVs on physical roads. Further, there may be test cases that are difficult to create or too dangerous to cover in the physical world. Accordingly, it may be desirable to train and validate AVs in a simulation environment.

A simulator may simulate (or mimic) real-world conditions (e.g., roads, lanes, buildings, obstacles, other traffic participants, trees, lighting conditions, weather conditions, etc.) so that the AV stack and/or AV compute process of an AV may be tested in a virtual environment that is close to a real physical world. Testing AVs in a simulator can be more efficient and allow for creation of specific traffic scenarios and/or specific road objects. To that end, the AV compute process implementing the perception, prediction, planning, and control algorithms can be developed, validated, and fine-tuned in a simulation environment. More specifically, sensors on an AV used for perception of a driving environment can be modeled in an AV simulator, the AV compute process may be executed in the AV simulator, and the AV simulator may compute metrics related to AV driving decisions, AV response time, etc. to determine the performance of an AV to be deployed with the AV compute process.

In some examples, a simulator may include a simulation of non-player characters (NPCs) in a driving environment. An NPC can be a human (e.g., a pedestrian, a cyclist) or another vehicle. In general, an NPC may be any road users. In a certain example, the simulator may create three-dimensional (3D) animation of pedestrians in various types of motions (e.g., crossing a road, walking, jogging, running, etc.) and may populate a simulated or virtual driving environment with these animated pedestrians to act as other road users do on a real-world road system. To that end, the simulator may generate a synthetic pedestrian and create movements of the pedestrian's arms, legs, feet, etc. in a 3D space to simulate a certain motion (e.g., crossing a road, walking, jogging, running, etc.).

One approach to generating 3D animation of pedestrian motions is to use motion capture (mocap) technology, which is a commonly used technology in filmmaking to record movements and translate the recorded movements into 3D animation. In this regard, mocap may use sensors and markers attached to human actors. In an example, a human actor may wear a mocap suit with sensors and markers (e.g., mocap marker) can be attached to the suit at the main moving joints or bones (e.g., head, neck, elbows, hips, knees, ankles, etc.) of the human actor are located. The actors may then perform various movements and be filmed on a special camera rig so that their movements can be translated into an animation later. While the mocap technology can provide 3D animation with a high accuracy, the process can be time consuming (e.g., taking days, or even months) and costly. Using mocap technology to generate 3D animation for AV simulation can thus be costly since there can be a great number of pedestrians in some traffic scenarios. For instance, a large crowd may be presence at a certain public area, for example, near the entrance of a cinema, a theatre, a ballpark, a shopping mall, a major crossing, etc. As such, a large number of human actors may be needed when using mocap technology. Accordingly, it may be undesirable and inefficient to use mocap technology to generate 3D animation for AV simulation.

In some examples, to facilitate training of certain AV compute models (e.g., for perception, prediction, planning, and/or control) and/or analysis of AV driving behaviors, a data collection vehicle (e.g., an AV) may be equipped with various sensors to collect data related to a real-world driving environment. The collected real-world driving data can be loaded into a simulator and may be rendered to create a virtual environment replicating the real-world driving environment. In certain examples, the data collection vehicle can include various cameras and LIDAR sensors (e.g., two-dimensional (2D) LIDAR sensors and/or 3D LIDAR sensors) mounted on different locations (e.g., left, right, back, front, top, etc.) of the vehicle. The vehicle may be driven around a physical city to collect real-world road data. In this regard, the cameras on the vehicle may capture 2D images of the environment surrounding the vehicle, and the LIDAR sensors may capture LIDAR point cloud (e.g., 2D and/or 3D point cloud) of the surrounding environment. The collected real-world road data may include various objects in the surrounding environment, for example, including, but not limited to, buildings, trees, other vehicles, pedestrian, cyclist, road signs, etc. The collected real-world road data may be processed offline, for example, for training and/or evaluating the performance of an AV compute process. Furthermore, AVs that are deployed on physical roads may also collect sensor data as part of its compute process to determine a perception of its surrounding so that an appropriate driving decision can be made. The sensor data can also be saved for further analysis. As such, a large amount of real-world road data may be collected between data collection vehicles and deployed AVs. The real-world road data can capture pedestrians in motion (e.g., crossing roads, walking, jogging, running, etc.) in the environment. Accordingly, the real-world road data may include a large amount of pedestrian motion information.

Disclosed herein are techniques for converting sensor-based object motions (e.g., pedestrian motions) collected from real-world road data into 3D animation. For instance, real-world road data (collected from a real-world driving environment) may include sensor data (e.g., camera images and/or LIDAR point clouds), where humans (or any characters) and associated movements can be isolated from the sensor data frame-by-frame. The movement information can be used to construct simple skeleton markers, which may in turn be treated like mocap markers. That is, instead of using the traditional mocap technology to create 3D animation, aspects of the present disclosure leverage (or reuse) real-world road data collected by data collection vehicles and/or AVs deployed in the real world to create 3D animation. In particular, the real-world road data may be annotated (or labeled) for use in training certain AV compute process (e.g., ML models for perception). Furthermore, as part of an AV simulation, an AV compute process may perform perception on the real-world road data to identify and/or detect objects in an environment provided by the real-world road data. Accordingly, aspects of the present disclosure may utilize the annotations and/or perceptions that are readily available for the real-world road data as a base for determining pedestrian motion information and may subsequently create 3D animation based on the determined pedestrian motion information. Certain aspects of the present disclosure may train an ML model to convert camera-based and/or LIDAR-based object motions into 3D animation.

According to an aspect of the present disclosure, a computer-implemented system (e.g., a simulation system) may obtain (or receive) real-world road data including a sequence images of a real-world driving environment across a time period. In an example, the real-world road data may be captured by data collection vehicle(s) and/or AV(s) deployed on physical roads. In some examples, each image in the sequence may correspond to a capture at a different time instant within the time period, and the images may be arranged sequentially in time. The sequence of images may include at least one moving character (e.g., a pedestrian in motion) in the real-world driving environment. For instance, at least two images in the sequence may include a capture of the moving character. The computer-implemented system may generate a sequence of skeletal data representing the moving character and corresponding movements across the time period by processing the real-world road data. The computer-implemented system may output a 3D motion library including the sequence of skeletal data. The 3D motion library may subsequently be used by an NPC simulator to create 3D animation of various characters in virtual driving environment.

In some aspects, each skeletal data in the sequence of skeletal data may include a set of skeletal markers corresponding to joints of the moving character at a different time instant within the time period. As used herein, skeletal markers may refer to labels, indicators, annotations, or meta data of any suitable format that indicate certain parts of a skeleton and may be in particular for indicating major bones and joints (e.g., associated with a head, a neck, a shoulder, an elbow, a hand, a hip, a knee, an ankle, a foot, etc.) that are involved with movements. In some aspects, each skeletal data in the sequence of skeletal data may include a set of interconnected bones and joints (e.g., stick figures) representing a skeleton of the moving character at a different time instant within the time period.

The sequence of skeletal data can be generated from the real-world road data in a variety of ways. In some aspects, as part of processing the real-world road data, the computer-implemented system may identify (or segment, isolate) the moving character from the sequence of images and identify the movements of the moving character across the time period. In general, the computer-implemented system may segment each character and each motion on a frame-by-frame basis. In some aspects, as part of identifying the movements of the moving character across the time period, the computer-implemented system may track motion information associated with at least one of a joint or a bone (e.g., associated with at least one of a head, a neck, a shoulder, an elbow, a hand, a hip, a knee, an ankle, or a foot) of the moving character across the time period, where the motion information may include at least one of a position, a traveling velocity, or a traveling direction. In some aspects, the generating the sequence of skeletal data may be further based on a correlation between the moving character and a reference coordinate system in a 3D space within the real-world driving environment. In some aspects, as part of processing the real-world road data, the computer-implemented system may use an ML model to process the real-world road data, where the ML model may be trained based on a training data set including images captured from a plurality of driving scenes across time and annotations associated with motions of one or more characters in the plurality of driving scenes.

In some aspects, the computer-implemented system may further obtain (or receive) perception data including an annotation indicating the moving character in at least one image of the sequence of images, and the generating the sequence of skeletal data may be further based on the perception data. As used herein, perception data may refer to processed or annotated road data, where the road data may be collected from a vehicle (e.g., using on-board sensors) while traversing a path (e.g., in a real-world driving environment) and the processing may include extracting information related to navigation and adding annotations to the road data based on the extracted information. In some examples, information extraction may include performing object identification (e.g., identifying a character in the environment, etc.).

In some aspects, the real-world road data may further include a sequence of LIDAR point clouds representing the real-world driving environment across the time period, where the sequence of LIDAR point clouds may include the at least one moving character. Accordingly, the computer-implemented system may generate the sequence of skeletal data using both the sequence of images and the sequence of LIDAR point clouds. In some aspects, the computer-implemented system may use an ML model to process the sequence of images and the sequence of LIDAR point clouds to generate the sequence of skeletal data.

In a further aspect, as part of processing the real-world road data, the computer-implemented system may project the moving character from a first image (e.g., a 2D image) in the sequence of images to a first LIDAR point cloud in the sequence of LIDAR point clouds. The computer-implemented system may determine a bounding box within the first LIDAR point cloud based on the projection. The computer-implemented system may generate a mesh object (a mesh character) based on data points within the bounding box. A mesh is a collection of vertices, edges, and faces that describe the shape of a 3D object, where a vertex is a single point, an edge is a straight line segment connecting two vertices, and a face is a flat surface enclosed by edges. The computer-implemented system may compute an average of at least a subset of vertices in the mesh object to a common vertex that corresponds to a joint of the moving character. Thus, the skeletal data may include skeletal markers indicating the common vertex computed from the mesh object.

According to some further aspects of the present disclosure, a computer-implemented system may train an ML model to be used for generating skeletal data from real-world road data as discussed above. For example, the computer-implemented system may receive sensor data (e.g., camera images and/or LIDAR data) captured from a real-world driving environment across a time period. The sensor data may include a capture of at least one moving character in the real-world driving environment. For instance, the sensor data may be part of real-world road data captured by data collection vehicle(s) or AV(s) deployed on physical roads. The computer-implemented system may generate, based on the sensor data, perception data including main annotations indicating the moving character and auxiliary annotations indicating movements of the moving character across the time period. The main annotations may refer to annotations that may be used as ground truth data for training ML model(s) used by AV perception, prediction, planning, and/or control, whereas the auxiliary annotations may refer to annotations that are specific to movements (or motions) of an object or a character. In other words, the auxiliary annotations may be specifically generated to facilitate 3D animation. As an example, a main annotation may simply include an identification of a human, whereas an auxiliary annotation may include an identification of a human joint (e.g., around a head, a neck, a shoulder, an elbow, a hand, a hip, a knee, an ankle, a foot, etc.) that provides movements. The computer-implemented system may train an ML model to generate skeletal markers using the sensor data and the perception data. In some aspects, the training the ML model may use the sensor data as training input and the perception data as training ground truth data. In other aspects, the training the ML model may use the sensor data and the main annotations from the perception data as training input and the auxiliary annotations from the perception data as training ground truth data.

The systems, schemes, and mechanisms described herein can advantageously utilize real-world road data collected from real-world driving environment(s) and/or perception data to generate 3D animation data. Since the real-world road data and/or perception data may already include rich information related to moving characters (e.g., actual road users in a real-world road system), 3D motion data and/or 3D animation can be generated quickly instead of taking days or even months with mocap technology. Further, the generation of the 3D motion data and/or 3D animation data are software processing based and thus the cost may be significantly low compared to hiring actors and mocap equipment that are needed when using mocap technology. Further, using ML model trained to convert real-world road data (AV sensor data or vehicle sensor data) to 3D animation can further improve performance and processing time.

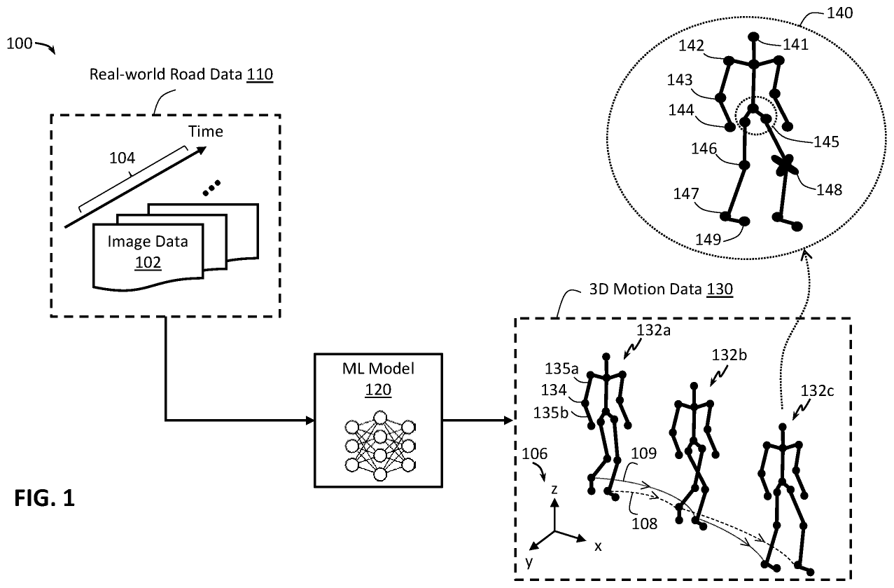

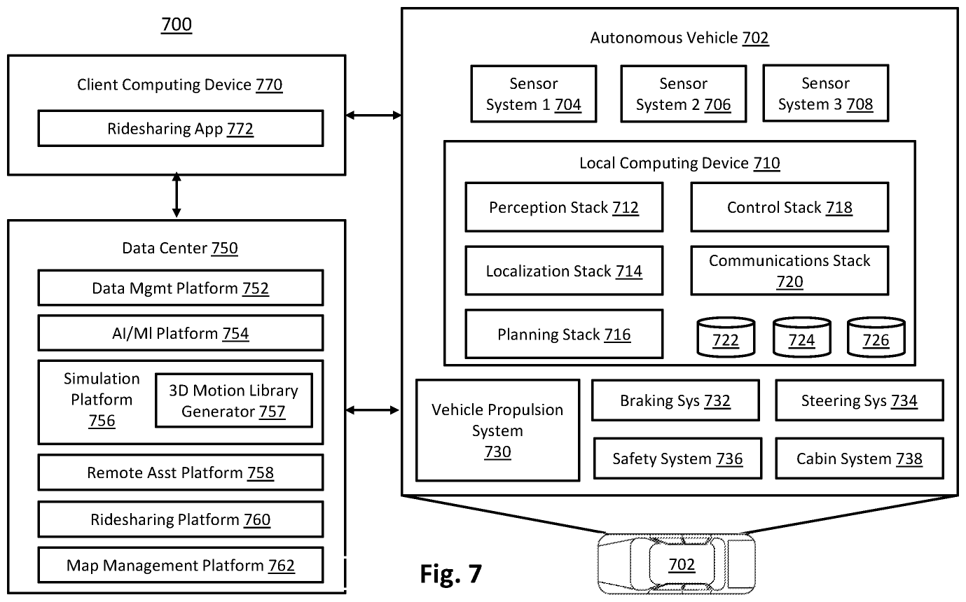

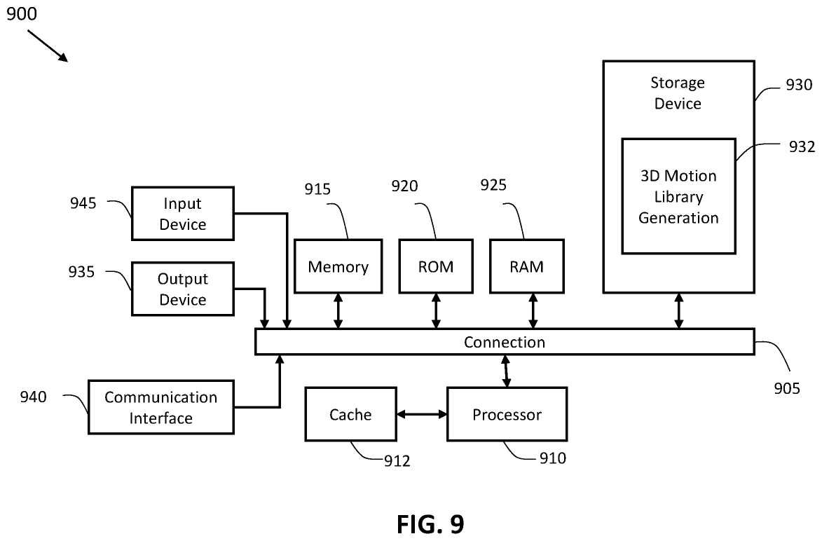

FIG. 1 illustrates an example 3D motion data generation scheme 100 that utilizes camera images, according to some examples of the present disclosure. The scheme 100 may be implemented by a computer-implemented system or a simulation system (e.g., the simulation platform 756 of FIG. 7, the 3D motion library generator module 757 of FIG. 7, and/or the processor-based system 900 of FIG. 9). At a high level, the computer-implemented system may receive real-world road data 110 and may process the real-world road data 110 using an ML model 120 to generate 3D motion data 130.

The real-world road data 110 may be captured by data collection vehicle(s) and/or AV(s) (e.g., the AV 702 of FIG. 7) deployed on physical roads. The real-world road data 110 may include sensor data captured by onboard sensors of the data collection vehicle(s) and/or onboard sensors of the AV(s). In the illustrated example of FIG. 1, the real-world road data 110 includes a sequence of image data frames 102 captured across a time period 104. Each image data frames 102 may be a 2D image captured by a camera sensor at a different time instant within the time period 104. The image data frames 102 may be arranged sequentially in time as shown. In an example, the sequence of image data frames 102 may include at least one moving object or character (e.g., a pedestrian) in the real-world driving environment.

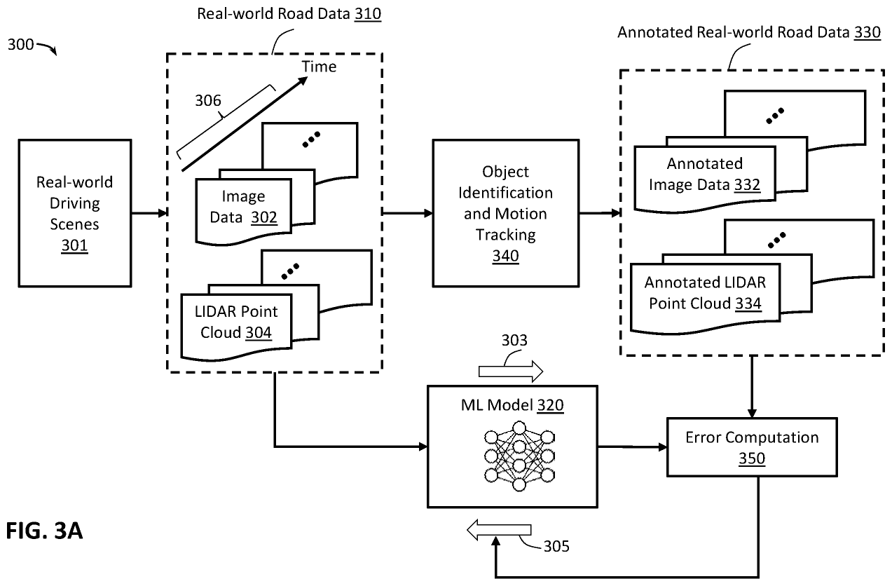

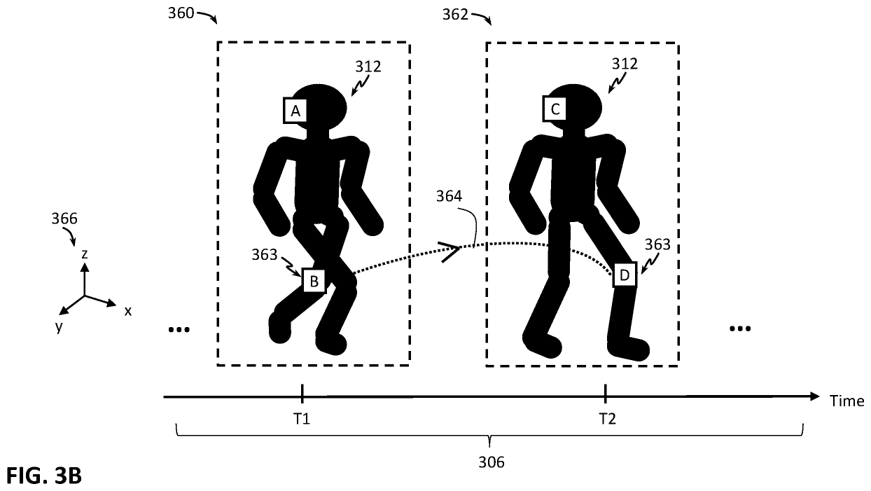

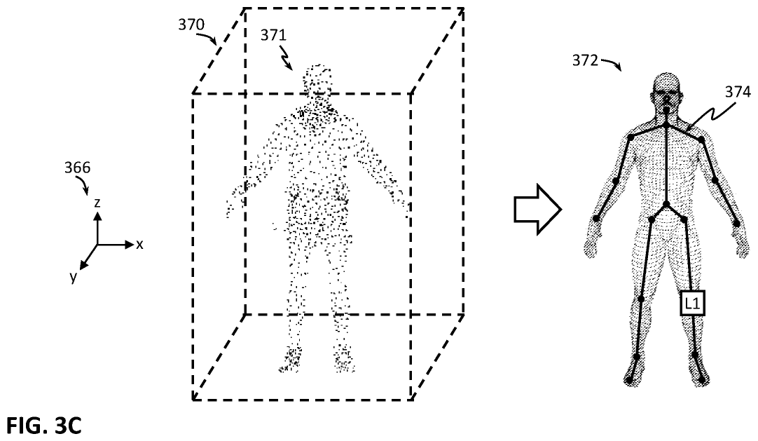

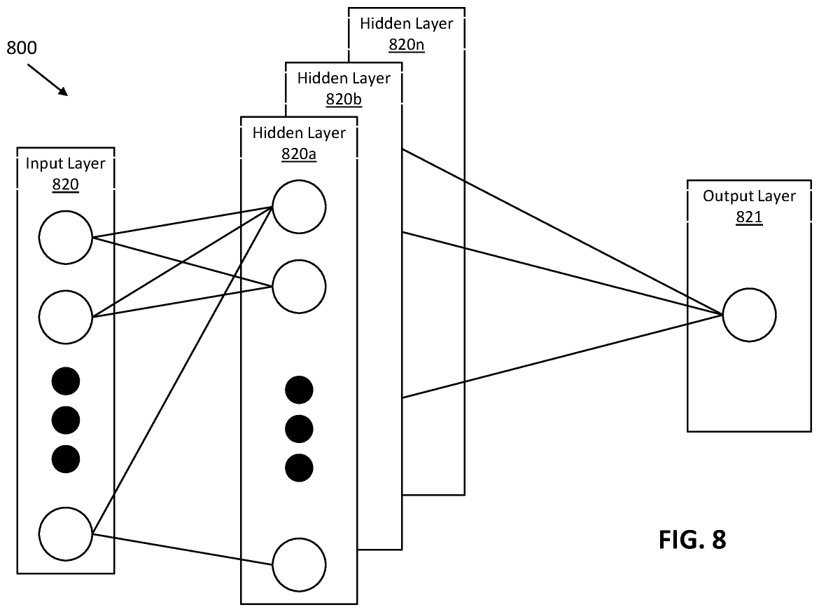

The ML model 120 may be trained to receive the real-world road data 110 as an input and may generate the 3D motion data 130. In some examples, the ML model 120 may be a neural network including a plurality of layers, for example, an input layer, followed by one or more hidden layers (e.g., fully connected layers, convolutional layers, and/or pooling layers) and an output layer. Each layer may include a set of weights and/or biases that can transform inputs received from a previous layer and the resulting outputs can be passed to the next layer. The weights and/or biases in each layer can be trained and adapted, for example, to perform certain predictions. In general, the ML model 120 can have any suitable architecture (e.g., a convolutional neural network, a recurrent neural network, a generative network, a discriminator network, etc.). In some examples, the ML model 120 may have an architecture similar to the deep learning model or neural network 800 of FIG. 8. As will be discussed more fully below with reference to FIG. 3A-3C, the ML model 120 may be trained based on sensor data (e.g., collected from onboard sensors data collection vehicle(s) and/or AV(s) deployed on physical roads) and/or perception data (e.g., processed by an AV perception software stack).

In general, the ML model 120 may be trained to perform the operations of converting the sequence of image data frames 102 into the 3D motion data 130. In some aspects, the operations may include identifying (e.g., segment or detect) character(s) (e.g., pedestrians(s)) from the image data frames 102 and identifying (e.g., segment or detect) movements associated with the respective object(s). As part of identifying the movements, motion information associated with at least one of a joint or a bone (e.g., associated with at least one of a head, a neck, a shoulder, an elbow, a hand, a hip, a knee, an ankle, or a foot) of the moving character may be tracked across the time period 104. That is, the ML model 120 may be trained to identify major bones and/or joints of a pedestrian and track corresponding motions. Because not all bones and joints of the moving character may significantly contribute to the main movements of the character, the ML model 120 may be trained to ignore those bones and joints that may not significantly contribute to the main movements. For instance, when the motion of interest is walking, joints and bones related to the fingers of the moving character can be ignored (not tracked) but joints and bones related to the limbs of the moving character can be tracked. The motion information may include at least one of a position, a traveling velocity, or a traveling direction of (the joints and/or bones of) the moving character. The operations may further include connecting the identified joints to create skeleton like structures (e.g., stick figures) as shown in the 3D motion data 130. The operations may further include determining a correlation between the moving character and a reference coordinate system (e.g., the reference coordinate system 106) in a 3D space within the real-world driving environment.

In some examples, a certain image data frame 102 may have an obstructed view of a certain joint or bone of the moving character, and thus the operations may further include recreating or predicting the joint or bone that are blocked. That is, the ML model 120 can be trained to re-create or predict joint(s) and/or bone(s) of the moving character when a respective image data frame 102 may has an obstructed view of the certain joint(s) or bone(s).

In some examples, because the data collection vehicle or the AV that collected the real-world road data 110 may be moving or driving around, the operations may further include taking into account of the movements (e.g., traveling direction or velocity) of the respective data collection vehicle or AV so that the tracked joint movements may be accurate. In some examples, the ML model 120 may be trained to segment character by character in an image data frame 102 and segment motions associated with each character frame-by-frame.

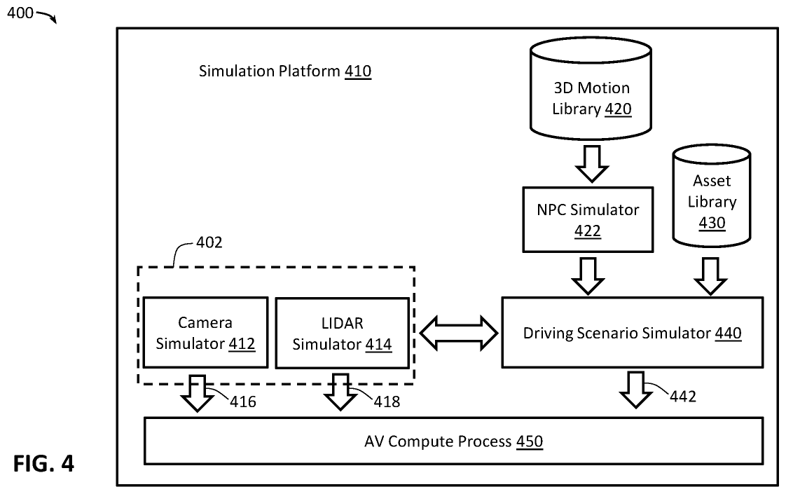

In the illustrated example of FIG. 1, the 3D motion data 130 may include a sequence of skeletal data 132 (shown as 132a, 132b, 132c). Each skeletal data 132 may be a 3D skeletal structure including a set of bones (shown by straight lines) interconnected by joints (shown by the solid circles) representing a skeleton of the moving character (captured by the image data 102) across the time period. For instance, the skeletal data 132a may be generated based on an image data frame 102 captured at a time instant t1 in the time period 104, the skeletal data 132b may be generated based on an image data frame 102 captured at a subsequent time instant t2 in the time period 104, and so on. In order to not clutter the drawings of FIG. 1, only one of the joints is labeled with a reference numeral 134 and corresponding bones interconnected by the joint 134 are labeled with reference numerals 135a and 135b. As shown by a more detailed view 140 of the skeletal data 132c, the joints are at the neck 141, shoulders 142, elbows 143, wrist 144, hip 145, knee 146, ankles 147, and foots 149 of the moving character. In some aspects, the sequence of skeletal data 132 may include a skeletal marker 148 placed on or attached to each joint. In order to not clutter the drawings of FIG. 1, only one skeletal marker 148 is placed on a knee joint of the skeletal structure in the skeletal data 132c. However, a similar skeletal marker can be placed at each joint of the skeletal structure. In some examples, a skeletal marker can be placed at a center of a joint (a major movement joint). Generally, the skeletal markers may be of any suitable shape and/or size and may be placed at any suitable location of a joint (a major movement joint). The skeletal markers can function as mocap markers, which may be used to generate 3D animation of pedestrian motions as will be discussed more fully below with reference to FIG. 4.

As further shown in FIG. 1, the moving character shown by the sequence of skeletal data 132 is performing a walking motion. As an example, the movements of the left joint of the moving character across time are shown by the arrows 108 with dashed lines and the movements of the right joint of the moving character across the same time period are shown by the arrows 109 with the dotted lines. The skeletal data 132 may be defined with respect to a reference coordinate system 106 (e.g., x-y-z coordinate system) in a 3D space of the real-world driving environment. As an example, the joint may be defined by a data point (e.g., an x-y-z coordinate) in the 3D space with respect to the reference coordinate system 106, and the bones 135a and 135b may be defined as vectors in the 3D space with respect to the reference coordinate system 106.

In some aspects, the computer-implemented system may generate various 3D motion data similar to the 3D motion data 130 for various types of pedestrian motions, for example, including but not limited to, jogging, running, crossing a road, etc. Further, the computer-implemented system may generate 3D motion data for pedestrians of different heights, different ages, and/or different sizes. The computer-implemented system may create a 3D motion library including the 3D motion data of different motions. The 3D motion library can be used to generate 3D animation of pedestrian motions as will be discussed more fully below with reference to FIG. 4.

While FIG. 1 illustrates the ML model 120 processing one sequence of image data frames 102, in other examples, the real-world road data 110 may include multiple sequences of image data frames captured by different cameras (e.g., mounted on different locations) on a data collection vehicle or AV, and the ML model 120 can process the multiple sequences of image data frames to generate the 3D motion data 130. Further, in some examples, the ML model 120 can generate one skeletal data 132 for each image data frame 102. In other examples, the ML model 120 can generate skeletal data 132 for some image data frames 102 but not for all image data frames 102 in the sequence.

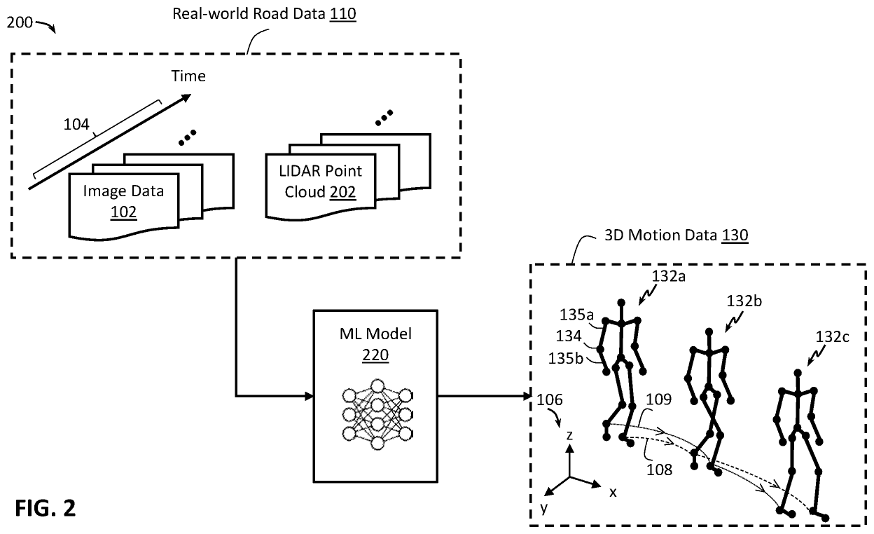

FIG. 2 illustrates an example 3D motion data generation scheme 200 that utilizes camera images and LIDAR data, according to some examples of the present disclosure. The scheme 200 may be implemented by a computer-implemented system or a simulation system (e.g., the simulation platform 756 of FIG. 7, the 3D motion library generator module 757 of FIG. 7, and/or the processor-based system 900 of FIG. 9). The scheme 200 may be similar to the scheme 100 in many respects and the same reference numerals as in FIG. 1 are used in FIG. 2 to refer to the same or analogous elements of FIG. 1; for brevity, a discussion of these elements is not repeated, and these elements may take the form of any of the embodiments disclosed herein. At a high level, in the scheme 200, the computer-implemented system may utilize LIDAR data point clouds 202 in addition to image data frames 102 to generate 3D motion data 130.

As shown in FIG. 2, the real-world road data 110 may further include a sequence of LIDAR data 202 (e.g., LIDAR point clouds) in addition to the sequence of image data frames 102. The sequence of image data frames 102 and the sequence of LIDAR point clouds 202 may be captured in a real-world driving environment across a time period 104. Each LIDAR point clouds 202 may be captured by a LIDAR sensor at a different time instant within the time period 104. The LIDAR point clouds 202 may be arranged sequentially in time as shown. In some examples, the LIDAR point clouds 202 may be 2D LIDAR point clouds. In other examples, the LIDAR point clouds 202 may be 3D LIDAR point clouds. As discussed above, the sequence of image data frames 102 may include at least one moving object or character (e.g., a pedestrian) in the real-world driving environment. The sequence of LIDAR point clouds 202 may include the same moving object or character as the sequence of image data frames 102.

In the scheme 200, the computer-implemented system may generate 3D motion data 130 by processing the sequence of image data frames 102 and the sequence of LIDAR point clouds 202 using an ML model 220. That is, the ML model 220 may take the sequence of image data frames 102 and the sequence of LIDAR point clouds 202 as input and may produce the 3D motion data 130. The ML model 220 may be substantially similar to the ML model 120 of FIG. 1 but may be trained on sensor data including image data frames and LIDAR point clouds. In some examples, the ML model 220 may have an architecture similar to the deep learning model or neural network 800 of FIG. 8.

In general, the ML model 220 may be trained to perform the operations of converting the sequence of image data frames 102 and the sequence of LIDAR point clouds 202 into the 3D motion data 130 including the sequence of skeletal data 132. In some aspects, the operations may include time-aligning (or time-registering) the sequence of image data frames 102 and the sequence of LIDAR point clouds 202. As an example, each image data frame 102 may have a corresponding LIDAR point cloud 202 captured at about the same time. The operations may include identifying (e.g., segment or detect) character(s) (e.g., pedestrians(s)) and identifying (e.g., segment or detect) movements associated with the respective object(s) from the image data frames 102 as discussed above with reference to FIG. 1. The operations may further include projecting the identified moving character from an individual image data frame 102 onto a respective LIDAR point cloud 202.

In some aspects, the operations may further include determining a 3D bounding box in the LIDAR point cloud 202 based on the projection. For instance, the 3D bounding box may enclose point cloud data representing the moving character (e.g., shown in FIG. 3C). The operations may further include extracting LIDAR data points (representing the moving character) from the 3D bounding box. The operations may further include generating a mesh object (a mesh character) based on extracted LIDAR data points. A mesh is a collection of vertices, edges, and faces that describe the shape of a 3D object, where a vertex is a single point, an edge is a straight line segment connecting two vertices, and a face is a flat surface enclosed by edges. The operations may further include compressing a subset of the vertices (e.g., around a major joint) in the mesh object to a common vertex corresponding to the respective joint. To that end, an average of a subset of vertices in the mesh object can be computed to generate the common vertex. As an example, the common vertex may correspond to a joint (e.g., the joint 134) of the skeletal data 132a. The process of averaging a subset of vertices to a common vertex may be performed around various locations, for example, around the head, neck, shoulders, elbows, wrists, hip, knees, ankles, feet, etc.

In some aspects, as part of generating the skeletal data 132, the operations can include placing skeletal markers (e.g., the skeletal marker 148) at the common vertex computed from the mesh object. The operations may also include tracking joint movements, correlating the locations and movements of the moving character to a reference coordinate system in a 3D space within the real-world driving environment, and/or taking into account of the traveling velocity and/or direction of the data collection vehicle or AV that collected the real-world road data 110 as discussed above with reference to FIG. 1.

While FIG. 2 illustrates the ML model 220 processing one sequence of image data frames 102 and one sequence of LIDAR point clouds 202, in some examples, the real-world road data 110 may include multiple sequences of image data frames captured by different cameras (e.g., mounted on different locations) and/or multiple sequences of LIDAR point clouds captured by different LIDAR sensors on a data collection vehicle or AV, and thus the ML model 220 can process multiple sequences of image data frames and/or multiple sequences of LIDAR point clouds to generate the 3D motion data 130. In general, the ML model 220 can process one or more sequences of image data frames and one or more sequences of LIDAR point clouds captured across a time period to generate the 3D motion data 130. Additionally, while FIG. 1 illustrates the sequence of image data frames 102 and the sequence of LIDAR point clouds 202 arranged as separate time series for input to the ML model 220, the sequence of image data frames 102 and the sequence of LIDAR point clouds 202 can be arranged in any suitable way. Further, the ML model 220 can generate one skeletal data 132 for each image data frame 102 and corresponding LIDAR point cloud 202. In other examples, the ML model 120 can generate skeletal data 132 for some image data frames 102 and/or LIDAR point clouds 202 but not for all image data frames 102 in the sequence and/or all LIDAR point clouds 202 in the sequence.

FIGS. 3A-3C are discussed in relation to each other. FIG. 3A illustrates an example ML model training scheme 300 for training a ML model 320 to generate 3D motion data from real-world road data, according to some examples of the present disclosure. The scheme 300 may be implemented by a computer-implemented system or a simulation system (e.g., the simulation platform 756 of FIG. 7, the 3D motion library generator module 757 of FIG. 7, and/or the processor-based system 900 of FIG. 9). The scheme 300 may be used to train the ML model 120 of FIG. 1 and/or the ML model 220 of FIG. 2. That is, the trained ML model 320 can be used in place of the ML model 120 in the scheme 100 or in place of the ML model 220 in the scheme 200 depending on the input training data set.

As shown in FIG. 3A, real-world road data 310 may be collected from various real-world driving scenes 301 (e.g., by data collection vehicle(s) and/or AV(s)). The real-world driving scenes 301 can include real-world driving scenes that are purposely created or simply real-world driving scenes that occur in a city. The real-world road data 310 may be stored at the respective vehicle during collection and uploaded to a storage (e.g., in a network) for post processing and/or analysis. The real-world road data 310 may include sensor data, for example, including multiple sequences of image data frames 302 and/or multiple sequences of LIDAR point clouds 304 captured from the real-world driving scenes 301 across various time periods. For simplicity of illustration and discussion, FIG. 3A illustrates one sequence of image data frames 302 and one sequence of LIDAR point clouds 304 across a time period 306. The real-world road data 310 may be used as training input data for training the ML model 320.

The object identification and motion tracking block 340 may be a software component executed by the computer-implemented system. The object identification and motion tracking block 340 may receive (or retrieve from network storage) the real-world road data 310. The object identification and motion tracking block 340 may process the real-world road data 310 to generate annotated (or labeled) real-world road data 330. In some instances, the annotated real-world road data 330 may generally be referred to as perception data as perception processing may be applied to the real-world road data 310 as will be discussed more fully below. The annotated real-world road data 330 may include a sequence of annotated image data frames 332 and a sequence of annotated LIDAR point clouds 334. The sequence of annotated image data frames 332 may correspond to the sequence of image data frames 302 and may include annotations (or labels) indicating moving objects (e.g., moving characters) in the image data frames 302. Similarly, the sequence of annotated LIDAR point clouds 334 may correspond to the sequence of LIDAR point clouds 304 and may include annotations (or labels) indicating moving objects (e.g., moving characters) in the LIDAR point clouds 304. In some examples, the annotations in the annotated image data 332 and/or the annotated LIDAR point clouds 334 may include indications of the type/classification (e.g., a pedestrian, a cyclist, etc.) of the object and/or movement joints (e.g., elbow, wrist, knee, hip, ankle, etc.). The ML model 320 may be trained using the real-world road data 310 and the annotated real-world road data 330. More specifically, the ML model 320 may be trained using sensor data from the real-world road data 310 and corresponding annotated sensor data.

In one aspect, the ML model 320 may be trained using image data frames 302 and the annotated image data frames 332. That is, the training of the ML model 320 may not use the LIDAR point clouds 304 and the annotated LIDAR point clouds 334. In such an aspect, the trained ML model 320 can be used as the ML model 120 in the scheme 100 of FIG. 1. In another aspect, the ML model 320 may be trained using the image data frames 302, the annotated image data frames 332, the LIDAR point clouds 304, and the annotated LIDAR point clouds 334. In such an aspect, the trained ML model 320 can be used as the ML model 220 in the scheme 200 of FIG. 2.

In some aspects, the object identification and motion tracking block 340 may perform various operations substantially similar to a perception compute process used by an AV software stack. In an example, the object identification and motion tracking block 340 may identify (e.g., segment or detect) character(s) (e.g., pedestrians(s)) from the image data frames 302 and identify (e.g., segment or detect) movements associated with the respective object(s). As part of identifying the movements, motion information associated with at least one of a joint or a bone (e.g., associated with at least one of a head, a shoulder, an elbow, a hand, a hip, a knee, an ankle, or a foot) of a moving character may be tracked across the time period 306. Because not all bones and joints of the moving character may significantly contribute to the main movements of the character, the object identification and motion tracking block 340 may exclude identification and/or tracking of those bones and joints that may not significantly contribute to the main movements. For instance, when the motion of interest is walking, joints and bones related to the fingers of the moving character can be ignored (not tracked) but joints and bones related to the limbs of the moving character can be tracked. The motion information may include at least one of a position, a traveling velocity, or a traveling direction of (the joints and/or bones of) the moving character. As part of identifying the movements of the moving character(s), the object identification and motion tracking block 340 may further determine a correlation between the moving character and a reference coordinate system (e.g., the reference coordinate system 106) in a 3D space within the real-world driving environment.

In some examples, a certain image data frame 302 may have an obstructed view of a certain joint or bone of the moving character, and thus the object identification and motion tracking block 340 may further include re-create or predict the joint or bone that are blocked. In some examples, because the data collection vehicle or the AV that collected the real-world road data 110 may be moving or driving around, the object identification and motion tracking block 340 may further include taking into account of the movements (e.g., traveling direction or velocity) of the respective data collection vehicle or AV so that the tracked joint movements may be accurate. In general, the object identification and motion tracking block 340 may process each image data frame 302 to identify character by character and track movements of each character from one image data frame 302 to another image data frame 302.

The object identification and motion tracking block 340 may add annotations to each image data frame 302 to create the annotated image data frames 302 based on the operations discussed above. The annotations (or labels) can include main annotations (or labels) and auxiliary annotations (or labels). The main annotations may refer to annotations that may be used as ground truth data for training ML model(s) used by AV perception, prediction, planning, and/or control, whereas the auxiliary annotations may refer to annotations that are specific to movements (or motions) of an object or a character. In other words, the auxiliary annotations may be specifically generated to facilitate 3D animation. As an example, a main annotation may simply include an identification of a human, whereas an auxiliary annotation may include an identification of a human joint (e.g., at the head, neck, shoulders, elbows, wrists, hip, knees, ankles, feet, etc.) that provides movements. An example of annotated sensor data is shown in FIG. 3B

FIG. 3B illustrates example annotated sensor data 360 and 362, according to some examples of the present disclosure. The annotated sensor data 360 may correspond to a first annotated image data frame 332 at a first time instant T1 in the time period 306. The annotated sensor data 362 may correspond to a second annotated image data frame 332 at second time instant T2 in the time period 306. In order to not clutter the drawings in FIG. 3B, only the moving character 312 captured by the image data frames 302 are shown. However, the annotated sensor data 360 and 362 can generally include other road objects in the respective real-world driving scenes 301 at the respective time instants T1 and T2.

As shown in FIG. 3B, the annotated sensor data 360 may include a main annotation (shown by the label A) labeling (or indicating) the moving character 312 as identified in a respective first image data frame 302 (captured at time T1) by the object identification and motion tracking block 340. Similarly, the annotated sensor data 362 may include a main annotation (shown by the label C) labeling (or indicating) the moving character 312 as identified in a respective second image data frame 302 (captured at time T2) by the object identification and motion tracking block 340. The annotated sensor data 360 may further include an auxiliary annotation (shown by the label B) indicating a moving joint (e.g., a left knee 363) of the moving character 312 at a first location. The annotated sensor data 362 may further include an auxiliary annotation (shown by the label D) indicating the moving joint (e.g., the left knee 363) of the moving character 312 at a second location different from the first location. The movement is shown by the dotted arrow 364. The object identification and motion tracking block 340 may track the movement of the moving joint 363 with respect to a reference coordinate system 366 (an x-y-z coordinate) in a 3D space of the respective real-world driving scene 301.

Returning to FIG. 3A, the object identification and motion tracking block 340 may also process the LIDAR point clouds 304 to generate annotated LIDAR point clouds 334 when the ML model 320 is trained to generate 3D motion data (e.g., the 3D motion data 130) from image data frames and LIDAR point clouds. In some aspects, the object identification and motion tracking block 340 may further time-align (or time-register) the sequence of image data frames 302 and the sequence of LIDAR point clouds 304. As an example, each image data frame 302 may have a corresponding LIDAR point cloud 304 captured at about the same time. The object identification and motion tracking block 340 may further project the identified moving character from an individual image data frame 302 onto a respective LIDAR point cloud 304. The object identification and motion tracking block 340 may determine a 3D bounding box (e.g., the 3D bounding box 370 shown in FIG. 3C) in the LIDAR point cloud 202 based on the projection. The object identification and motion tracking block 340 may further generate a mesh object (e.g., the mesh object 372 shown in FIG. 3C) representing the moving character based on the LIDAR data points in the 3D bounding box. An example of a 3D bounding box enclosing the moving character and an example of a mesh object representing the moving character are shown in FIG. 3C.

FIG. 3C illustrates an example 3D bounding box 370 enclosing LIDAR data points 371 representing a moving character (e.g., in one of the LIDAR point cloud 304) and a mesh object 372 representing the moving character, according to some examples of the present disclosure. The mesh object 372 can be generated from the LIDAR data points 371. As can be seen in FIG. 3C, the mesh object 372 may include a collection of vertices, edges, and faces that describe the shape of the moving character. The object identification and motion tracking block 340 may further average a subset of the vertices around each of major movement joints (e.g., around the neck, shoulders, elbows, wrists, hip, knees, ankles, feet, etc.) to a common vertex as shown by the solid circles. The common vertices may correspond to the center of those movement joints. The object identification and motion tracking block 340 may further annotate (or label) each of those common vertices or joints. In order to not clutter the drawings of FIG. 3C, only one label L1 for the left knee is shown. In some examples, the object identification and motion tracking block 340 may further connect the common vertices to generate a skeletal structure 374 similar to the skeletal data 132 shown in FIGS. 1 and 2. In some examples, the common vertices and/or the lines connecting the common vertices may be defined with respect to the reference coordinate system 366 in a 3D space of the real-world driving environment.

Returning to FIG. 3A, after the object identification and motion tracking block 340 generated the annotated real-world road data 330, the ML model 320 may be trained using the real-world road data 310 and the annotated real-world road data 330. In one aspect, the real-world road data 310 may be used as training input data and the annotated real-world road data 330 may be used as training ground truth data. In this regard, the real-world road data 310 or more specifically the sequence of image data frames 302 and the sequence of LIDAR point clouds 304 may be input to the ML model 320 and propagated through each layer of the ML model 320 in a forward direction (e.g., a forward propagation process 303). More specifically, the ML model 320 may process the sequence of image data frames 302 and the sequence of LIDAR point clouds 304 at each layer of the ML model 320 according to respective parameters such as weights and/or biases for the layer. An error computation block 350 (a software component executed by the computer-implemented system) may compute an error based on the ML model 320's output and the annotated real-world road data 330 (e.g., the ground truth or target data). and determine a loss based on the error. The loss may be used to update the ML model 320, for example, by performing a backpropagation process 305 through the layers of the ML model 320 while adjusting the weights and/or biases at each layer of the ML model 320. The forward propagation process 303 and the backpropagation process 305 can be repeated until the error is minimized or the loss metric satisfies certain criteria.

In another aspect, the real-world road data 310 and the main annotations (e.g., the labels A and C that label the moving character shown in FIG. 3B) may be used as training input data and the auxiliary annotations (e.g., the labels B and D that label the moving joints of the moving character in FIG. 3B) may be used as training ground truth data. In other words, a first set of annotated data including the sequence of image data frames 302 and the sequence of LIDAR point clouds 304 with main annotations may be input to the ML model 320 and propagated through each layer of the ML model 320 and a second set of annotated data including the sequence of image data frames 302 and the sequence of LIDAR point clouds 304 with auxiliary annotations may be used as the target or ground truth data. Accordingly, the error computation block 350 may compute an error based on the ML model 320's output and the second set of annotated data. Subsequently, the parameters (e.g., weights and/or biases for each layer) of the ML model 320 may be adjusted based on the computed error as discussed above.

In some aspects, the ML model 320 may be trained based on camera images only. That is, LIDAR data can be omitted from the training. For instance, the ML model 320 may be trained using the sequence of image data frames 302 as training input data and the sequence of annotated image data frames 332 as ground truth. Alternatively, the ML model 320 may be trained using a first set of annotated data including the sequence of image data frames 302 with main annotations (e.g., labels labeling moving character(s)) as training input data and a second set of annotated data including the sequence of image data frames 302 with auxiliary annotations (e.g., labels labeling main moving joints of moving character(s)) as ground truth.

FIG. 4 illustrates an example simulation platform 400 with 3D animation for training, development, and/or testing of an AV software stack, according to some examples of the present disclosure. The simulation platform 400 may be implemented by a computer-implemented system or a simulation system (e.g., the simulation platform 756 of FIG. 7 and/or the processor-based system 900 of FIG. 9). The simulation platform 400 may utilize 3D motion data generated as shown in the scheme 100 of FIG. 1 and/or the scheme 200 of FIG. 2 to create 3D animations of road users in an AV simulation.

As shown in FIG. 4, the simulation platform 400 may include a 3D motion library 420, an NPC simulator 422, an asset library 430, a driving scenario simulation 440, and a sensor simulator 402. The 3D motion library 420 (a database) may include various 3D motion data (e.g., including various sequences of skeletal data 132 for different types of motions such as walking, jogging, running, etc.). The asset library 430 (a database) may include other road objects (e.g., stationary objects such as trees, buildings, road signs, traffic lights, etc.). The 3D motion library 420 and the asset library 430 may be stored at a memory of the simulation platform 410 as shown in FIG. 4. In some examples, the 3D motion library 420 and the asset library 430 may be stored at a network storage or cloud storage and can be accessed by the simulation platform 410. The NPC simulator 422, the driving scenario simulation 440, and the sensor simulator 402 may be software components that can be executed by processor(s) and/or processing unit(s) (e.g., CPUs, GPUs, DSPs, ASIPs, ML engines, etc.) of the simulation platform 410 to create a synthetic driving environment 442 for testing an AV software stack (e.g., an AC compute process 450).

In an aspect, the NPC simulator 422 may create 3D animation of various road users or characters based on 3D motion data provided by the 3D motion library 420. In an example, the NPC simulator 422 may take a sequence of skeletal data from the 3D motion library 420 and generate a pedestrian in motion. The driving scenario simulator 440 may generate a synthetic driving environment 442 by populating various assets obtained from the asset library 430 and/or various pedestrians in motion generated by the NPC simulator 422 on a synthetic roadway system. In some examples, the driving scenario simulator 440 may render real-world road data captured from driving in a real-world roadway system and may augment the replay with various assets obtained from the asset library 430 and/or various pedestrians in motion generated by the NPC simulator 422.

In an aspect, the sensor simulator 402 may include a camera simulator 412 and a LIDAR simulator 414. The sensor simulator 402 may also include other sensor simulators such as a radio detection and ranging (RADAR) simulator, a location simulator, etc., that are commonly used by an AV compute process to train, develop, and/or evaluate an AV behavior. In an example, the camera simulator 412 may implement a model that generates images 416 based on the synthetic driving environment 442 provided by the driving scenario simulator 440. In this regard, the camera simulation model may compute physical properties provided by a certain camera sensor. For instance, the camera simulation model may generate images 416 having colors, intensities, pixel densities, etc. that resemble the certain camera sensor. In an example, the LIDAR simulator 414 may implement a model that generates LIDAR point clouds 418 based on the synthetic driving environment 442 provided by the driving scenario simulator 440. In this regard, the LIDAR simulation may compute physical properties provided by a certain LIDAR sensor. For instance, the LIDAR sensor model may generate LIDAR returns 418 (e.g., LIDAR data points) having intensities, distributions, densities, etc. that resemble the LIDAR returns generated by the certain LIDAR sensor.

The AV compute process 450 can be trained, developed, and/or evaluated in the synthetic driving environment 442. In some instances, the AV compute process 450 can perception, prediction, path planning, and/or control to determine a driving decision in the synthetic driving environment 442. In some instances, the AV compute process 450 may receive sensor data (e.g., the images 416 and the LIDAR point clouds 418) from the sensor simulator 402 and may perform perception based on the received sensor data. In some instances, interactions of the AV compute process 450 and the NPC(s) generated by the NPC simulator can be evaluated to ensure the AV compute process 450 may perform well when deployed in an AV driving in a driving environment similar to the synthetic driving environment 442.

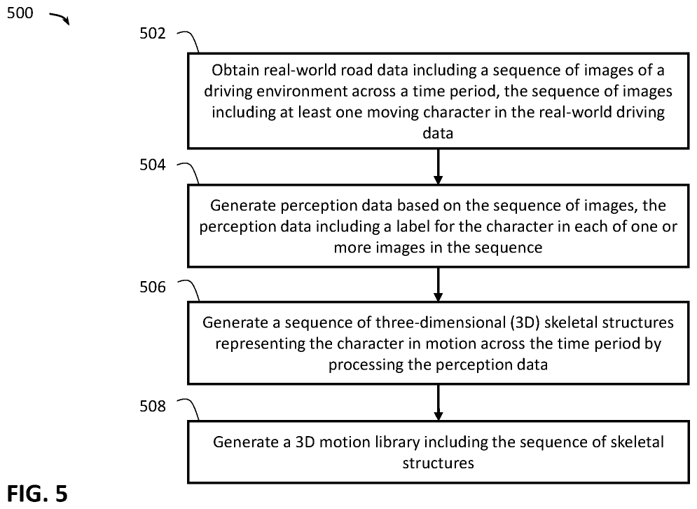

FIG. 5 is a flow diagram illustrating a process 500 for generating a 3D motion library from real-world road data captures, according to some examples of the present disclosure. The process 500 can be implemented by a computer-implemented system or a simulation system (e.g., the simulation platform 756 of FIG. 7 and/or the processor-based system 900 of FIG. 9). In general, the process 500 may be performed using any suitable hardware components and/or software components. The process 500 may utilize similar mechanisms discussed above with reference to FIGS. 1-2 and 4. Operations are illustrated once each and in a particular order in FIG. 5, but the operations may be performed in parallel, reordered, and/or repeated as desired.

At 502, the computer-implemented system may obtain real-world road data including a sequence of images of a real-world driving environment across a time period. The sequence of images may include at least one character in motion in the real-world driving environment. In some examples, the real-world road data may correspond to the real-world road data 110 and/or 310, and the sequence of images may correspond to the sequence image data frames 102 and/or 302.

At 504, the computer-implemented system may generate perception data based on the sequence of images. The perception data may include a label for the character in each of one or more images in the sequence. In some examples, the label may be similar to the labels A and C (or main annotations) discussed above with reference to FIG. 3B.

At 506, the computer-implemented system may generate a sequence of 3D skeletal structures (e.g., the skeletal data 132) representing the character in motion across the time period by processing the perception data. In some aspects, as part of processing the perception data, the computer-implemented system may track motion information associated with at least one of a joint or a bone of the character across the time period. The motion information may include at least one of a position, a traveling velocity, or a traveling direction of the moving character. In some aspects, the at least one of the joint or the bone of the character for which the motion information is tracked is associated with at least one of a head, a neck, a shoulder, an elbow, a hand, a hip, a knee, an ankle, or a foot of the character, for example, as shown in FIGS. 1, 2, and 3C. In some aspects, as part of processing the perception data, the computer-implemented system may process the perception data using an ML model (e.g., the ML models 120, 220, and/or 320). The ML model may be trained based on a training data set including images captured from a plurality of driving scenes across time and annotations associated with motions of one or more characters in the plurality of driving scenes, for example, as discussed above with reference to FIGS. 3A-3C.

At 508, the computer-implemented system may generate a motion library including the sequence of 3D skeletal structures. The motion library may store the sequence of 3D skeletal structures in any suitable data format (e.g., in a loadable binary image). In some examples, the motion library can also include application programming interfaces (APIs) that a simulation code can call to instantiate a certain sequence of 3D skeletal structures. The motion library may generally include a collection of sequences of 3D skeletal structures for various types of motions (e.g., crossing a road, walking, jogging, running, etc.). In some examples, the motion library may correspond to the 3D motion data 130 and/or the 3D motion library 420. The computer-implemented system may output the motion library for use by other simulators (e.g., the NPC simulator 422 of FIG. 4).

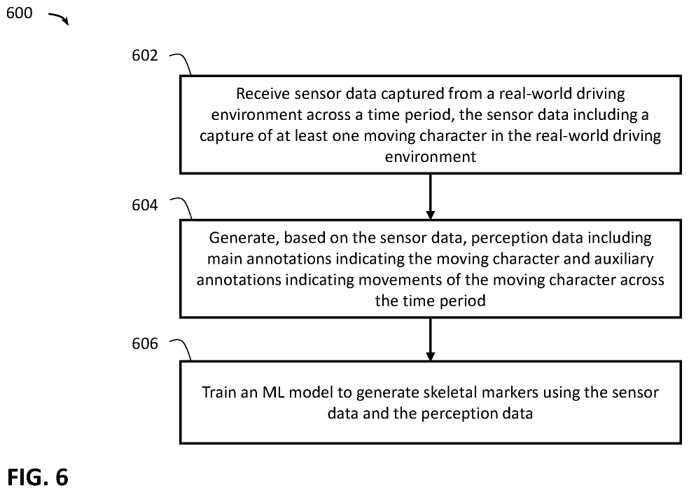

FIG. 6 is a flow diagram illustrate a process 600 for training an ML model to generate a 3D motion library from real-world road data captures, according to some examples of the present disclosure. The process 600 can be implemented by a computer-implemented system or a simulation system (e.g., the simulation platform 756 of FIG. 7 and/or the processor-based system 900 of FIG. 9). In general, the process 600 may be performed using any suitable hardware components and/or software components. The process 600 may utilize similar mechanisms discussed above with reference to FIGS. 1-2 and 3A-3C. Operations are illustrated once each and in a particular order in FIG. 6, but the operations may be performed in parallel, reordered, and/or repeated as desired.

At 602, the computer-implemented system may receive sensor data captured from a real-world driving environment across a time period. The sensor data may include a capture of at least one moving character in the real-world driving environment. In some aspects, the sensor data may include a sequence of images (e.g., the sequence of images data frames 102 and/or 302) captured across the time period. In some aspects, the sensor data may include a sequence of LIDAR point clouds (e.g., the sequence of LIDAR point clouds 202 and/or 304) captured across the time period. In some aspects, the sensor data may include a sequence of images and a sequence of LIDAR point clouds captured across the time period.

At 604, the computer-implemented system may generate, based on the sensor data, perception data (e.g., the annotated real-world road data 330) including main annotations (e.g., the labels A and B shown in FIG. 3B) indicating the moving character and auxiliary annotations indicating movements of the moving character across the time period. In some aspects, the perception data may include a first annotation (e.g., the label C shown in FIG. 3B) of the auxiliary annotations in a first frame of the sensor data and a second annotation (e.g., the label D shown in FIG. 3B) of the auxiliary annotations in a second frame of the sensor data, where the first frame and the second frame may be associated with different time instants within the time period. The first annotation indicates a first location of a joint of the character within a 3D of the real-world driving environment, and the second annotation indicates a second location of the character's joint within the 3D space, where the second location is different from the first location. In some aspects, the joint may be associated with at least one of a head, a neck, a shoulder, an elbow, a hand, a hip, a knee, an ankle, or a foot of the character of the moving character.

At 606, the computer-implemented system may train an ML model (e.g., the ML model 120, 220, and/or 320) to generate skeletal markers (e.g., the skeletal marker 148 shown in FIG. 1) using the sensor data and the perception data. In some aspects, the training the ML model may use the sensor data as training input and the perception data as training ground truth data. In other aspects, the training the ML model may use the sensor data and the main annotations from the perception data as training input and the auxiliary annotations from the perception data as training ground truth data.

Turning now to FIG. 7, this figure illustrates an example of an AV management system 700. One of ordinary skill in the art will understand that, for the AV management system 700 and any system discussed in the present disclosure, there may be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 700 includes an AV 702, a data center 750, and a client computing device 770. The AV 702, the data center 750, and the client computing device 770 may communicate with one another over one or more networks (not shown), such as a public network (e.g., the Internet, an Infrastructure as a Service (IaaS) network, a Platform as a Service (PaaS) network, a Software as a Service (SaaS) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 702 may navigate about roadways without a human driver based on sensor signals generated by multiple sensor systems 704, 706, and 708. The sensor systems 704-608 may include different types of sensors and may be arranged about the AV 702. For instance, the sensor systems 704-608 may comprise Inertial Measurement Units (IMUs), cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 704 may be a camera system, the sensor system 706 may be a LIDAR system, and the sensor system 708 may be a RADAR system. Other embodiments may include any other number and type of sensors.

AV 702 may also include several mechanical systems that may be used to maneuver or operate AV 702. For instance, the mechanical systems may include vehicle propulsion system 730, braking system 732, steering system 734, safety system 736, and cabin system 738, among other systems. Vehicle propulsion system 730 may include an electric motor, an internal combustion engine, or both. The braking system 732 may include an engine brake, a wheel braking system (e.g., a disc braking system that utilizes brake pads), hydraulics, actuators, and/or any other suitable componentry configured to assist in decelerating AV 702. The steering system 734 may include suitable componentry configured to control the direction of movement of the AV 702 during navigation. Safety system 736 may include lights and signal indicators, a parking brake, airbags, and so forth. The cabin system 738 may include cabin temperature control systems, in-cabin entertainment systems, and so forth. In some embodiments, the AV 702 may not include human driver actuators (e.g., steering wheel, handbrake, foot brake pedal, foot accelerator pedal, turn signal lever, window wipers, etc.) for controlling the AV 702. Instead, the cabin system 738 may include one or more client interfaces (e.g., Graphical User Interfaces (GUIs), Voice User Interfaces (VUIs), etc.) for controlling certain aspects of the mechanical systems 730-738.

AV 702 may additionally include a local computing device 710 that is in communication with the sensor systems 704-708, the mechanical systems 730-738, the data center 750, and the client computing device 770, among other systems. The local computing device 710 may include one or more processors and memory, including instructions that may be executed by the one or more processors. The instructions may make up one or more software stacks or components responsible for controlling the AV 702; communicating with the data center 750, the client computing device 770, and other systems; receiving inputs from riders, passengers, and other entities within the AV's environment; logging metrics collected by the sensor systems 704-708; and so forth. In this example, the local computing device 710 includes a perception stack 712, a mapping and localization stack 714, a planning stack 716, a control stack 718, a communications stack 720, a High Definition (HD) geospatial database 722, a 3D motion database 726, and an AV operational database 724, among other stacks and systems.

Perception stack 712 may enable the AV 702 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 704-608, the mapping and localization stack 714, the HD geospatial database 722, other components of the AV, and other data sources (e.g., the data center 750, the client computing device 770, third-party data sources, etc.). The perception stack 712 may detect and classify objects and determine their current and predicted locations, speeds, directions, and the like. In addition, the perception stack 712 may determine the free space around the AV 702 (e.g., to maintain a safe distance from other objects, change lanes, park the AV, etc.). The perception stack 712 may also identify environmental uncertainties, such as where to look for moving objects, flag areas that may be obscured or blocked from view, and so forth.

Mapping and localization stack 714 may determine the AV's position and orientation (pose) using different methods from multiple systems (e.g., GPS, IMUs, cameras, LIDAR, RADAR, ultrasonic sensors, the HD geospatial database 722, etc.). For example, in some embodiments, the AV 702 may compare sensor data captured in real-time by the sensor systems 704-608 to data in the HD geospatial database 722 to determine its precise (e.g., accurate to the order of a few centimeters or less) position and orientation. The AV 702 may focus its search based on sensor data from one or more first sensor systems (e.g., GPS) by matching sensor data from one or more second sensor systems (e.g., LIDAR). If the mapping and localization information from one system is unavailable, the AV 702 may use mapping and localization information from a redundant system and/or from remote data sources.

The planning stack 716 may determine how to maneuver or operate the AV 702 safely and efficiently in its environment. For example, the planning stack 716 may receive the location, speed, and direction of the AV 702, geospatial data, data regarding objects sharing the road with the AV 702 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, Double-Parked Vehicles (DPVs), etc.), traffic rules and other safety standards or practices for the road, user input, and other relevant data for directing the AV 702 from one point to another. The planning stack 716 may determine multiple sets of one or more mechanical operations that the AV 702 may perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 716 may select from multiple backup plans to carry out. For example, while preparing to change lanes to turn right at an intersection, another vehicle may aggressively cut into the destination lane, making the lane change unsafe. The planning stack 716 could have already determined an alternative plan for such an event, and upon its occurrence, help to direct the AV 702 to go around the block instead of blocking a current lane while waiting for an opening to change lanes.

The control stack 718 may manage the operation of the vehicle propulsion system 730, the braking system 732, the steering system 734, the safety system 736, and the cabin system 738. The control stack 718 may receive sensor signals from the sensor systems 704-608 as well as communicate with other stacks or components of the local computing device 710 or a remote system (e.g., the data center 750) to effectuate operation of the AV 702. For example, the control stack 718 may implement the final path or actions from the multiple paths or actions provided by the planning stack 716. Implementation may involve turning the routes and decisions from the planning stack 716 into commands for the actuators that control the AV's steering, throttle, brake, and drive unit.

The communication stack 720 may transmit and receive signals between the various stacks and other components of the AV 702 and between the AV 702, the data center 750, the client computing device 770, and other remote systems. The communication stack 720 may enable the local computing device 710 to exchange information remotely over a network, such as through an antenna array or interface that may provide a metropolitan WIFI® network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 720 may also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 722 may store HD maps and related data of the streets upon which the AV 702 travels. In some embodiments, the HD maps and related data may comprise multiple layers, such as an areas layer, a lanes and boundaries layer, an intersections layer, a traffic controls layer, and so forth. The areas layer may include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer may include geospatial information of road lanes (e.g., lane or road centerline, lane boundaries, type of lane boundaries, etc.) and related attributes (e.g., direction of travel, speed limit, lane type, etc.). The lanes and boundaries layer may also include 3D attributes related to lanes (e.g., slope, elevation, curvature, etc.). The intersections layer may include geospatial information of intersections (e.g., crosswalks, stop lines, turning lane centerlines, and/or boundaries, etc.) and related attributes (e.g., permissive, protected/permissive, or protected only left turn lanes; permissive, protected/permissive, or protected only U-turn lanes; permissive or protected only right turn lanes; etc.). The traffic controls layer may include geospatial information of traffic signal lights, traffic signs, and other road objects and related attributes.

The AV operational database 724 may store raw AV data generated by the sensor systems 704-708 and other components of the AV 702 and/or data received by the AV 702 from remote systems (e.g., the data center 750, the client computing device 770, etc.). In some embodiments, the raw AV data may include HD LIDAR point cloud data, image or video data, RADAR data, GPS data, and other sensor data that the data center 750 may use for creating or updating AV geospatial data.

The 3D motion database 726 may store sequences of skeletal data (e.g., the 3D motion data 130) generated by the 3D motion library generator module 757. In some examples, the 3D motion database 726 may be similar to the 3D motion library 420 discussed herein.

The data center 750 may be a private cloud (e.g., an enterprise network, a co-location provider network, etc.), a public cloud (e.g., an IaaS network, a PaaS network, a SaaS network, or other CSP network), a hybrid cloud, a multi-cloud, and so forth. The data center 750 may include one or more computing devices remote to the local computing device 710 for managing a fleet of AVs and AV-related services. For example, in addition to managing the AV 702, the data center 750 may also support a ridesharing service, a delivery service, a remote/roadside assistance service, street services (e.g., street mapping, street patrol, street cleaning, street metering, parking reservation, etc.), and the like.

The data center 750 may send and receive various signals to and from the AV 702 and the client computing device 770. These signals may include sensor data captured by the sensor systems 704-708, roadside assistance requests, software updates, ridesharing pick-up and drop-off instructions, and so forth. In this example, the data center 750 includes one or more of a data management platform 752, an Artificial Intelligence/Machine Learning (AI/ML) platform 754, a simulation platform 756, a remote assistance platform 758, a ridesharing platform 760, and a map management platform 762, among other systems.

Data management platform 752 may be a “big data” system capable of receiving and transmitting data at high speeds (e.g., near real-time or real-time), processing a large variety of data, and storing large volumes of data (e.g., terabytes, petabytes, or more of data). The varieties of data may include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 750 may access data stored by the data management platform 752 to provide their respective services.

The AI/ML platform 754 may provide the infrastructure for training and evaluating machine learning algorithms for operating the AV 702, the simulation platform 756, the remote assistance platform 758, the ridesharing platform 760, the map management platform 762, and other platforms and systems. Using the AI/ML platform 754, data scientists may prepare data sets from the data management platform 752; select, design, and train machine learning models; evaluate, refine, and deploy the models; maintain, monitor, and retrain the models; and so on.

The simulation platform 756 may enable testing and validation of the algorithms, ML models, neural networks, and other development efforts for the AV 702, the remote assistance platform 758, the ridesharing platform 760, the map management platform 762, and other platforms and systems. The simulation platform 756 may replicate a variety of driving environments and/or reproduce real-world scenarios from data captured by the AV 702, including rendering geospatial information and road infrastructure (e.g., streets, lanes, crosswalks, traffic lights, stop signs, etc.) obtained from the map management platform 762; modeling the behavior of other vehicles, bicycles, pedestrians, and other dynamic elements; simulating inclement weather conditions, different traffic scenarios; and so on. In some embodiments, the simulation platform 756 may include a 3D motion library generator module 757 that converts sensor-based motions to 3D motion data as discussed herein.

The remote assistance platform 758 may generate and transmit instructions regarding the operation of the AV 702. For example, in response to an output of the AI/ML platform 754 or other system of the data center 750, the remote assistance platform 758 may prepare instructions for one or more stacks or other components of the AV 702.

The ridesharing platform 760 may interact with a customer of a ridesharing service via a ridesharing application 772 executing on the client computing device 770. The client computing device 770 may be any type of computing system, including a server, desktop computer, laptop, tablet, smartphone, smart wearable device (e.g., smart watch; smart eyeglasses or other Head-Mounted Display (HMD); smart car pods or other smart in-car, on-car, or over-ear device; etc.), gaming system, or other general purpose computing device for accessing the ridesharing application 772. The client computing device 770 may be a customer's mobile computing device or a computing device integrated with the AV 702 (e.g., the local computing device 710). The ridesharing platform 760 may receive requests to be picked up or dropped off from the ridesharing application 772 and dispatch the AV 702 for the trip.

Map management platform 762 may provide a set of tools for the manipulation and management of geographic and spatial (geospatial) and related attribute data. The data management platform 752 may receive LIDAR point cloud data, image data (e.g., still image, video, etc.), RADAR data, GPS data, and other sensor data (e.g., raw data) from one or more AVs 702, Unmanned Aerial Vehicles (UAVs), satellites, third-party mapping services, and other sources of geospatially referenced data. The raw data may be processed, and map management platform 762 may render base representations (e.g., tiles (2D), bounding volumes (3D), etc.) of the AV geospatial data to enable users to view, query, label, edit, and otherwise interact with the data. Map management platform 762 may manage workflows and tasks for operating on the AV geospatial data. Map management platform 762 may control access to the AV geospatial data, including granting or limiting access to the AV geospatial data based on user-based, role-based, group-based, task-based, and other attribute-based access control mechanisms. Map management platform 762 may provide version control for the AV geospatial data, such as to track specific changes that (human or machine) map editors have made to the data and to revert changes when necessary. Map management platform 762 may administer release management of the AV geospatial data, including distributing suitable iterations of the data to different users, computing devices, AVs, and other consumers of HD maps. Map management platform 762 may provide analytics regarding the AV geospatial data and related data, such as to generate insights relating to the throughput and quality of mapping tasks.

In some embodiments, the map viewing services of map management platform 762 may be modularized and deployed as part of one or more of the platforms and systems of the data center 750. For example, the AI/ML platform 754 may incorporate the map viewing services for visualizing the effectiveness of various object detection or object classification models, the simulation platform 756 may incorporate the map viewing services for recreating and visualizing certain driving scenarios, the remote assistance platform 758 may incorporate the map viewing services for replaying traffic incidents to facilitate and coordinate aid, the ridesharing platform 760 may incorporate the map viewing services into the client application 772 to enable passengers to view the AV 702 in transit enroute to a pick-up or drop-off location, and so on.

FIG. 8 is an illustrative example of a deep learning neural network 800 that may be used to generate all or a portion of a 3D motion library (e.g., the 3D motion library 420 of FIG. 4 and the 3D motion database 726 of FIG. 7) as discussed above. In some examples, the deep learning neural network 800 may correspond to the ML models 120, 220, and/or 320 discussed above. An input layer 820 may be configured to receive sensor data and/or data relating to an environment surrounding an AV. The neural network 800 includes multiple hidden layers 822a. 822b, through 822n. The hidden layers 822a, 822b, through 822n include “n” number of hidden layers, where “n” is an integer greater than or equal to one. The number of hidden layers may be made to include as many layers as needed for the given application. The neural network 800 further includes an output layer 821 that provides an output resulting from the processing performed by the hidden layers 822a, 822b, through 822n. In one illustrative example, the output layer 821 may provide estimated treatment parameters, that may be used/ingested by a differential simulator to estimate a patient treatment outcome.

The neural network 800 is a multi-layer neural network of interconnected nodes. Each node may represent a piece of information. Information associated with the nodes is shared among the different layers and each layer retains information as information is processed. In some cases, the neural network 800 may include a feed-forward network, in which case there are no feedback connections where outputs of the network are fed back into itself. In some cases, the neural network 800 may include a recurrent neural network, which may have loops that allow information to be carried across nodes while reading in input.

Information may be exchanged between nodes through node-to-node interconnections between the various layers. Nodes of the input layer 820 may activate a set of nodes in the first hidden layer 822a. For example, as shown, each of the input nodes of the input layer 820 is connected to each of the nodes of the first hidden layer 822a. The nodes of the first hidden layer 822a may transform the information of each input node by applying activation functions to the input node information. The information derived from the transformation may then be passed to and may activate the nodes of the next hidden layer 822b, which may perform their own designated functions. Example functions include convolutional, up-sampling, data transformation, and/or any other suitable functions. The output of the hidden layer 822b may then activate nodes of the next hidden layer, and so on. The output of the last hidden layer 822n may activate one or more nodes of the output layer 821, at which an output is provided. In some cases, while nodes in the neural network 800 are shown as having multiple output lines, a node may have a single output and all lines shown as being output from a node represent the same output value.

In some cases, each node or interconnection between nodes may have a weight that is a set of parameters derived from the training of the neural network 800. Once the neural network 800 is trained, it may be referred to as a trained neural network, which may be used to classify one or more activities. For example, an interconnection between nodes may represent a piece of information learnt about the interconnected nodes. The interconnection may have a tunable numeric weight that may be tuned (e.g., based on a training dataset), allowing the neural network 800 to be adaptive to inputs and able to learn as more and more data is processed.

The neural network 800 is pre-trained to process the features from the data in the input layer 820 using the different hidden layers 822a, 822b, through 822n in order to provide the output through the output layer 821.

In some cases, the neural network 800 may adjust the weights of the nodes using a training process called backpropagation. A backpropagation process may include a forward pass, a loss function, a backward pass, and a weight update. The forward pass, loss function, backward pass, and parameter/weight update is performed for one training iteration. The process may be repeated for a certain number of iterations for each set of training data until the neural network 800 is trained well enough so that the weights of the layers are accurately tuned.

To perform training, a loss function may be used to analyze error in the output. Any suitable loss function definition may be used, such as a Cross-Entropy loss. Another example of a loss function includes the mean squared error (MSE), defined as Eₜₒₜₐₗ=Σ(½(target−output)²). The loss may be set to be equal to the value of Eₜₒₜₐₗ.

The loss (or error) will be high for the initial training data since the actual values will be much different than the predicted output. The goal of training is to minimize the amount of loss so that the predicted output is the same as the training output. The neural network 800 may perform a backward pass by determining which inputs (weights) most contributed to the loss of the network, and may adjust the weights so that the loss decreases and is eventually minimized.

The neural network 800 may include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The neural network 800 may include any other deep network other than a CNN, such as an autoencoder, Deep Belief Nets (DBNs), Recurrent Neural Networks (RNNs), among others.

As understood by those of skill in the art, machine-learning based classification techniques may vary depending on the desired implementation. For example, machine-learning classification schemes may utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

ML classification models may also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models may employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

FIG. 9 illustrates an example processor-based system with which some aspects of the subject technology may be implemented. For example, processor-based system 900 may be any computing device making up, or any component thereof in which the components of the system are in communication with each other using connection 905. Connection 905 may be a physical connection via a bus, or a direct connection into processor 910, such as in a chipset architecture. Connection 905 may also be a virtual connection, networked connection, or logical connection.

In some embodiments, computing system 900 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 900 includes at least one processing unit (CPU or processor) 910 and connection 905 that couples various system components including system memory 915, such as Read-Only Memory (ROM) 920 and Random-Access Memory (RAM) 925 to processor 910. Computing system 900 may include a cache of high-speed memory 912 connected directly with, in close proximity to, or integrated as part of processor 910.

Processor 910 may include any general-purpose processor and a hardware service or software service, such as a 3D motion library generation software 932 (that implements the schemes 100, 200, and/or 300 discussed herein) stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which may represent any number of input mechanisms, such as a microphone for speech, a touch-sensitive screen for gesture or graphical input, keyboard, mouse, motion input, speech, etc. Computing system 900 may also include output device 935, which may be one or more of a number of output mechanisms known to those of skill in the art. In some instances, multimodal systems may enable a user to provide multiple types of input/output to communicate with computing system 900. Computing system 900 may include communications interface 940, which may generally govern and manage the user input and system output. The communication interface may perform or facilitate receipt and/or transmission wired or wireless communications via wired and/or wireless transceivers, including those making use of an audio jack/plug, a microphone jack/plug, a USB port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, WLAN signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 940 may also include one or more GNSS receivers or transceivers that are used to determine a location of the computing system 900 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, RAM, Atatic RAM (SRAM), Dynamic RAM (DRAM), ROM, Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 930 may include software services, servers, services, etc., that when the code that defines such software is executed by the processor 910, it causes the system 900 to perform a function. In some embodiments, a hardware service that performs a particular function may include the software component stored in a computer-readable medium in connection with the necessary hardware components, such as processor 910, connection 905, output device 935, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices may be any available device that may be accessed by a general-purpose or special purpose computer, including the functional design of any special purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### SELECTED EXAMPLES

Example 1 includes a computer-implemented system, including one or more processing units; and one or more non-transitory computer-readable media storing instructions, when executed by the one or more processing units, cause the one or more processing units to perform operations including obtaining real-world road data including a sequence of images of a real-world driving environment across a time period, the sequence of images including at least one moving character in the real-world driving environment; generating a sequence of skeletal data representing the moving character and corresponding movements across the time period by processing the real-world road data; and generating a motion library including the sequence of skeletal data.

In Example 2, the computer-implemented system of example 1 can optionally include where the processing the real-world road data includes identifying the moving character from the sequence of images; and identifying the movements of the moving character across the time period.

In Example 3, the computer-implemented system of any of examples 1-2 can optionally include where the identifying the movements of the moving character across the time period includes tracking motion information associated with at least one of a joint or a bone of the moving character across the time period, the motion information including at least one of a position, a traveling velocity, or a traveling direction.

In Example 4, the computer-implemented system of any of examples 1-3 can optionally include where the at least one of the joint or the bone of the character for which the motion information is tracked is associated with at least one of a head, a shoulder, an elbow, a hand, a hip, a knee, or an ankle of the moving character.

In Example 5, the computer-implemented system of any of examples 1-4 can optionally include where the operations further include obtaining perception data including an annotation indicating the moving character in at least one image of the sequence of images; and the generating the sequence of skeletal data is further based on the perception data.

In Example 6, the computer-implemented system of any of examples 1-5 can optionally include where the generating the sequence of skeletal data is further based on a correlation between the moving character and a reference coordinate system in a three-dimensional (3D) space within the real-world driving environment.

In Example 7, the computer-implemented system of any of examples 1-6 can optionally include where each skeletal data in the sequence of skeletal data includes a set of skeletal markers corresponding to joints of the moving character at a different time instant within the time period.

In Example 8, the computer-implemented system of any of examples 1-7 can optionally include where each skeletal data in the sequence of skeletal data includes a set of interconnected bones and joints representing a skeleton of the moving character at a different time instant within the time period.

In Example 9, the computer-implemented system of any of examples 1-8 can optionally include where the generating the sequence of skeletal data includes processing the real-world road data using a machine learning (ML) model, the ML model trained based on a training data set including images captured from a plurality of driving scenes across time and annotations associated with motions of one or more characters in the plurality of driving scenes.

In Example 10, the computer-implement system of any of examples 1-9 can optionally include where the real-world road data further includes a sequence of light detection and ranging (LIDAR) point clouds representing the real-world driving environment across the time period, the sequence of LIDAR point clouds including the at least one moving character.

In Example 11, the computer-implement system of any of examples 1-10 can optionally include where the processing the real-world road data further includes generating, based on a first LIDAR point cloud in the sequence of LIDAR point clouds, a mesh object representing the moving character at a first time instant within the time period; and averaging at least a subset of vertices in the mesh object to a common vertex, the common vertex corresponding to a joint of the moving character.

In Example 12, the computer-implement system of any of examples 1-11 can optionally include where the generating the mesh object representing the moving character at the first time instant includes projecting the moving character from a first image in the sequence of images to the first LIDAR point cloud; determining, based on the projecting, a bounded box within the first LIDAR point cloud; and generating, based on LIDAR data points within the bounded box, the mesh object.

In Example 13, the computer-implement system of any of examples 1-12 can optionally include where the common vertex in the mesh object is associated with at least one of a neck, a shoulder, an elbow, a hand, a hip, a knee, or an ankle of the moving character.

Example 14 includes a computer-implemented system, including one or more processing units; and one or more non-transitory computer-readable media storing instructions, when executed by the one or more processing units, cause the one or more processing units to perform operations including receiving sensor data captured from a real-world driving environment across a time period, the sensor data including a capture of at least one moving character in the real-world driving environment; generating, based on the sensor data, perception data including main annotations indicating the moving character and auxiliary annotations indicating movements of the moving character across the time period; and training a machine learning (ML) model to generate skeletal markers using the sensor data and the perception data.

In Example 15, the computer-implemented system of example 14 can optionally include where the sensor data includes at least one of a sequence of images or a sequence of light detection and ranging (LIDAR) point clouds captured across the time period.

In Example 16, the computer-implemented system of any of examples 14-15 can optionally include where the perception data include a first annotation of the auxiliary annotations in a first frame of the sensor data and a second annotation of the auxiliary annotations in a second frame of the sensor data, the first frame and the second frame associated with different time instants within the time period; the first annotation indicates a first location of a joint of the character within a three-dimensional (3D) space of the real-world driving environment; and the second annotation indicates a second location of the character's joint within the 3D space, the second location being different from the first location.

In Example 17, the computer-implemented system of any of examples 14-16 can optionally include where the joint is associated with a shoulder, an elbow, a hand, a hip, or an ankle of a character at least one of a head, a shoulder, an elbow, a hand, a hip, a knee, or an ankle of the moving character.

In Example 18, the computer-implemented system of any of examples 14-17 can optionally include where the operations further include segmenting the moving character from the sensor data; segmenting the movements of the moving character from the sensor data; and adding an annotation to indicate the moving character and two or more annotations to indicate joint movements of the moving character across the time period.

In Example 19, the computer-implemented system of any of examples 14-18 can optionally include where the sensor data includes a plurality of sensor data frames across the time period; and the segmenting the moving character and the segmenting the movements of the moving character are performed for each of the plurality of sensor data frames.

In Example 20, the computer-implemented system of any of examples 14-19 can optionally include where the training the ML model uses the sensor data as training input and the perception data as training ground truth data.

In Example 21, the computer-implemented system of any of examples 14-19 can optionally include where the training the ML model uses the sensor data and the main annotations from the perception data as training input and the auxiliary annotations from the perception data as training ground truth data.

Example 22 includes a method including obtaining real-world road data including a sequence of images of a real-world driving environment across a time period, the sequence of images including at least one character in motion in the real-world driving environment; generating perception data based on the sequence of images, the perception data including a label for the character in each of one or more images in the sequence; processing the perception data to generate a sequence of three-dimensional (3D) skeletal structures representing the character in motion across the time period; and outputting a motion library including the sequence of 3D skeletal structures.

In Example 23, the method of example 22 can optionally include where the processing the perception data includes tracking motion information associated with at least one of a joint or a bone of the character across the time period, the motion information including at least one of a position, a traveling velocity, or a traveling direction.

In Example 24, the method of any of examples 22-23 can optionally include where the at least one of the joint or the bone of the character for which the motion information is tracked is associated with at least one of a head, a shoulder, an elbow, a hand, a hip, a knee, or an ankle of the character.

In Example 25, the method of any of examples 22-24 can optionally include where the processing the perception data includes applying a machine learning (ML) model to the perception data, the ML model trained based on a training data set including images captured from a plurality of driving scenes across time and annotations associated with motions of one or more characters in the plurality of driving scenes.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

1. A computer-implemented system, comprising:
one or more processing units; and
one or more non-transitory computer-readable media storing instructions, when executed by the one or more processing units, cause the one or more processing units to perform operations comprising:
obtaining real-world road data including a sequence of images of a real-world driving environment across a time period, the sequence of images including at least one moving character in the real-world driving environment;
generating a sequence of skeletal data representing the moving character and corresponding movements across the time period by processing the real-world road data; and
generating a motion library including the sequence of skeletal data.

2. The computer-implemented system of claim 1, wherein the processing the real-world road data comprises:
identifying the moving character from the sequence of images; and
identifying the movements of the moving character across the time period.

3. The computer-implemented system of claim 1, wherein the identifying the movements of the moving character across the time period comprises:
tracking motion information associated with at least one of a joint or a bone of the moving character across the time period, the motion information including at least one of a position, a traveling velocity, or a traveling direction.

4. The computer-implemented system of claim 3, wherein the at least one of the joint or the bone of the character for which the motion information is tracked is associated with at least one of a head, a neck, a shoulder, an elbow, a hand, a hip, a knee, an ankle, or a foot of the moving character.

5. The computer-implemented system of claim 1, wherein:
the operations further comprise obtaining perception data including an annotation indicating the moving character in at least one image of the sequence of images; and
the generating the sequence of skeletal data is further based on the perception data.

6. The computer-implemented system of claim 1, wherein the generating the sequence of skeletal data is further based on a correlation between the moving character and a reference coordinate system in a three-dimensional (3D) space within the real-world driving environment.

7. The computer-implemented system of claim 1, wherein each skeletal data in the sequence of skeletal data includes a set of skeletal markers corresponding to joints of the moving character at a different time instant within the time period.

8. The computer-implemented system of claim 1, wherein each skeletal data in the sequence of skeletal data includes a set of interconnected bones and joints representing a skeleton of the moving character at a different time instant within the time period.

9. The computer-implemented system of claim 1, wherein the generating the sequence of skeletal data comprises:
processing the real-world road data using a machine learning (ML) model, the ML model trained based on a training data set including images captured from a plurality of driving scenes across time and annotations associated with motions of one or more characters in the plurality of driving scenes.

10. The computer-implement system of claim 1, wherein:
the real-world road data further comprises a sequence of light detection and ranging (LIDAR) point clouds representing the real-world driving environment across the time period, the sequence of LIDAR point clouds including the at least one moving character.

11. A computer-implemented system, comprising:
one or more processing units; and
one or more non-transitory computer-readable media storing instructions, when executed by the one or more processing units, cause the one or more processing units to perform operations comprising:
receiving sensor data captured from a real-world driving environment across a time period, the sensor data including a capture of at least one moving character in the real-world driving environment;
generating, based on the sensor data, perception data including main annotations indicating the moving character and auxiliary annotations indicating movements of the moving character across the time period; and
training a machine learning (ML) model to generate skeletal markers using the sensor data and the perception data.

12. The computer-implemented system of claim 11, wherein the sensor data includes at least one a sequence of images or a sequence of light detection and ranging (LIDAR) point clouds captured across the time period.

13. The computer-implemented system of claim 11, wherein:
the perception data include a first annotation of the auxiliary annotations in a first frame of the sensor data and a second annotation of the auxiliary annotations in a second frame of the sensor data, the first frame and the second frame associated with different time instants within the time period;
the first annotation indicates a first location of a joint of the character within a three-dimensional (3D) space of the real-world driving environment; and
the second annotation indicates a second location of the character's joint within the 3D space, the second location being different from the first location.

14. The computer-implemented system of claim 13, wherein the joint is associated with at least one of a head, a neck, a shoulder, an elbow, a hand, a hip, a knee, an ankle, or a foot of the character of the moving character.

15. The computer-implemented system of claim 11, wherein the training the ML model uses the sensor data as training input and the perception data as training ground truth data.

16. The computer-implemented system of claim 11, wherein the training the ML model uses the sensor data and the main annotations from the perception data as training input and the auxiliary annotations from the perception data as training ground truth data.

17. A method comprising:
obtaining, by a computer-implemented system, real-world road data including a sequence of images of a real-world driving environment across a time period, the sequence of images including at least one character in motion in the real-world driving environment;
generating, by the computer-implemented system, perception data based on the sequence of images, the perception data including a label for the character in each of one or more images in the sequence;
generating, by the computer-implemented system, a sequence of three-dimensional (3D) skeletal structures representing the character in motion across the time period by processing the perception data; and
outputting, by the computer-implemented system, a motion library including the sequence of 3D skeletal structures.

18. The method of claim 17, wherein the processing the perception data comprises:
tracking motion information associated with at least one of a joint or a bone of the character across the time period, the motion information including at least one of a position, a traveling velocity, or a traveling direction.

19. The method of claim 18, wherein the at least one of the joint or the bone of the character for which the motion information is tracked is associated with at least one of a head, a neck, a shoulder, an elbow, a hand, a hip, a knee, an ankle, or a foot of the character.

20. The method of claim 17, wherein the processing the perception data comprises:
processing the perception data using a machine learning (ML) model, the ML model trained based on a training data set including images captured from a plurality of driving scenes across time and annotations associated with motions of one or more characters in the plurality of driving scenes.
